(19) United States
(12) Patent Application Publication
(10) Pub. No.: US 2025/0174699 A1
(43) Pub. Date: May 29, 2025

(54) Sealing Apparatus and Secondary Battery Manufactured by the Same

(71) Applicant: LG Energy Solution, Ltd., Seoul (KR)

(72) Inventors: Hyun Sang Lee, Daejeon (KR); Jung Doo Kim, Daejeon (KR)

(73) Assignee: LG Energy Solution, Ltd., Seoul (KR)

(21) Appl. No.: 18/951,130

(22) Filed: Nov. 18, 2024

(30) Foreign Application Priority Data
Nov. 29, 2023 (KR) 10-2023-0169882
Aug. 20, 2024 (KR) 10-2024-0111492

(51) Int. Cl. H01M 10/04; H01M 50/105; H01M 50/184; H01M 50/186; H01M 50/249; H01M 50/534

(52) U.S. Cl. CPC H01M 10/0404; H01M 50/105; H01M 50/184; H01M 50/186; H01M 50/249; H01M 50/534

(57) ABSTRACT

Disclosed herein is a sealing apparatus. The sealing apparatus may include a sealing block configured to seal a lead film covering a lead metal and a pouch covering the lead film. The sealing block may include a first sealing surface configured to seal a central portion of the lead film that overlaps the lead metal. The first sealing surface may include a center sealing surface, and a side sealing surface located at two sides of the center sealing surface and stepped with the center sealing surface. The side sealing surface may have a sealing protrusion that protrudes to a predetermined thickness in a direction in which the sealing block applies pressure to prevent the lead film from flowing in a width direction of the sealing surface.

### CROSS-REFERENCE TO RELATED APPLICATIONS

The present application claims priority to Korean Patent Application No. 10-2023-0169882 filed on Nov. 29, 2023, and Korean Patent Application No. 10-2024-0111492 filed on Aug. 20, 2024, in the Republic of Korea, the disclosures of which are incorporated herein by reference in their entirety.

### TECHNICAL FIELD

The present disclosure relates to a sealing apparatus and a secondary battery manufactured by the same, and more particularly, to a sealing apparatus for sealing an outer packaging material or a pouch of a secondary battery, and a pouch-type secondary battery manufactured by the same.

### BACKGROUND

Secondary batteries offer significant environmental benefits by reducing fossil fuel dependency and eliminating by-products associated with conventional energy sources. As a result, they are gaining recognition as a sustainable and efficient energy solution. Secondary batteries are gaining attention as a new energy source due to their potential to enhance environmental friendliness and energy efficiency. They significantly reduce the reliance on fossil fuels and produce no byproducts during energy consumption.

In manufacturing pouch-type secondary batteries, a lead film covering a lead metal is thermally bonded to the battery's packaging material or pouch using a heating block or jig that applies both heat and pressure. When heated, the inner adhesive layer of the pouch (such as a polypropylene layer) becomes flowable, allowing it to adhere through a controlled cooling process.

However, during adhesion, the adhesive layer can often thin and spread outward due to the applied heat and pressure, leading to a phenomenon known as squeeze out. This effect can cause the bonded layer to develop V-shaped indentations, pointed edges, or irregular undulations, which ultimately compromise the durability and quality of the pouch-type secondary battery.

Therefore, there exists a need for an improved sealing apparatus and a secondary battery manufactured by the same.

### BRIEF SUMMARY

The present disclosure is designed to solve, inter alia, the above-described problem, and therefore the present disclosure includes a sealing apparatus for reducing the volume of void between a lead film and a pouch.

The present disclosure is further directed to providing a sealing apparatus for preventing a lead film covering a lead metal from flowing in an inward-outward direction of a pouch during sealing.

The present disclosure is further directed to providing a secondary battery having high quality manufactured by the sealing apparatus.

A sealing apparatus according to an embodiment of the present disclosure may include a sealing block configured to seal a lead film covering a lead metal and a pouch covering the lead film. The sealing block may include a first sealing surface configured to seal a central portion of the lead film that overlaps the lead metal. The first sealing surface may include a center sealing surface; and a side sealing surface located at two sides of the center sealing surface and stepped with the center sealing surface. The side sealing surface may have a sealing protrusion that protrudes to a predetermined thickness in a direction in which the sealing block applies pressure, in order to prevent the lead film from flowing in a width direction of the sealing surface.

The side sealing surface may be extended from an end portion of the center sealing surface, and be stepped from the center sealing surface in the direction of pressure applied.

The sealing block may further include a second sealing surface stepped with the first sealing surface to seal two end portions of the lead film and the pouch.

The center sealing surface, the side sealing surface and the second sealing surface may be stepped in a sequential order in the direction of pressure applied.

The side sealing surface may overlap an end area of the lead metal in the width direction.

An inclined portion extended at an angle between an end portion of the side sealing surface and an end portion of the second sealing surface may be present between the side sealing surface and the second sealing surface.

The sealing protrusion may be extended along a length direction perpendicular to the width direction of the side sealing surface.

The sealing protrusion may include a plurality of sealing protrusions arranged at a predetermined interval in a width direction of the side sealing surface.

The sealing protrusion may be formed at edges of the side sealing surface in a width direction.

The sealing protrusions may include a first sealing protrusion formed at an edge of the side sealing surface in the width direction, and a second sealing protrusion formed at an opposite edge of the side sealing surface in the width direction.

The sealing protrusion may be extended to the second sealing surface over the side sealing surface.

The sealing block may include a pair of sealing blocks arranged facing each other in the direction of pressure applied.

A secondary battery according to an embodiment of the present disclosure may include a pouch including an accommodation portion accommodating an electrode assembly, and a sealing portion disposed around the accommodation portion; a lead metal connected to the electrode assembly and protruded outward over the sealing portion; and a lead film covering the lead metal and sealed with the sealing portion. The sealing portion may include a first area where the pouch and the lead film are sealed, the first area overlapping the lead metal. The first area may include a center area; and a side area located at two sides of the center area and stepped with the center area. The side area may have a pressed portion extended in a length direction of the side area.

The pressed portion may include a pair of pressed portions extended parallel to each other and arranged at a predetermined interval in a width direction of the side area.

The pressed portion may be formed at two edges of the side area in a width direction.

The sealing portion may further include a second area where two end portions of the lead film and the pouch are sealed, the second area being stepped with the first area.

In a thickness direction of the sealing portion, the center area, the side area and the second area may be stepped in a sequential order.

The sealing portion may further include an inclined area formed between the side area and the second area, and extended at an angle between an end portion of the side sealing surface and an end portion of the second sealing surface.

The pressed portion may be extended to the second area over the side area.

The center area, the side area and the pressed portion may be located at two surfaces of the sealing portion.

According to an embodiment of the present disclosure, it may be possible to reduce the size of void between the lead film and the pouch. Accordingly, it may be possible to improve durability and quality of the pouch-type secondary battery.

Additionally, it may be possible to prevent the lead film covering the lead metal from flowing in an inward-outward direction of the pouch during sealing. Accordingly, it may be possible to improve durability and quality of the pouch-type secondary battery.

Besides, the effects of the present disclosure may include effects that can be easily predicted by those skilled in the art from the embodiments of the present disclosure.

### BRIEF DESCRIPTION OF THE DRAWINGS

FIG. 1 is a perspective view of a pouch-type secondary battery.

FIG. 2 is a perspective view of a sealing block of a sealing apparatus according to a comparative example.

FIG. 3 is an enlarged view of section B of FIG. 2.

FIG. 4 is a cross-sectional view of FIG. 1, taken along the line I-I′, showing a secondary battery manufactured by the sealing apparatus of the comparative example of FIG. 2.

FIG. 5 is an enlarged plan view of the sealing portion of a pouch formed by the sealing apparatus of the comparative example of FIG. 2 and a lead film adjacent thereto.

FIG. 6 is a cross-sectional view of FIG. 5 taken along the line II-II′.

FIG. 7 is a diagram showing a lead film protruding in a width direction of a sealing surface during sealing.

FIG. 8 is a perspective view of a sealing block of a sealing apparatus according to an embodiment of the present disclosure.

FIG. 9 is an enlarged view of section C of FIG. 8.

FIG. 10 is a cross-sectional view of FIG. 1, taken along the line I-I′, showing a secondary battery manufactured by the sealing apparatus of FIG. 8 according to an embodiment of the present disclosure.

FIG. 11 is an enlarged plan view of a sealing portion of a pouch formed by the sealing apparatus of FIG. 8 and a lead film adjacent thereto according to an embodiment of the present disclosure.

FIG. 12 is a cross-sectional view of FIG. 11 taken along the line III-III′.

FIG. 13 is an enlarged plan view of a sealing portion of a pouch formed by the sealing apparatus of FIG. 8 and a lead film adjacent thereto according to an embodiment of the present disclosure.

### DETAILED DESCRIPTION

Hereinafter, embodiments of the present disclosure will be described in sufficient detail with reference to the accompanying drawings to enable persons having ordinary skill in the technical field pertaining to the present disclosure to easily carry out the present disclosure. To preserve focus on the core aspects of the present disclosure, descriptions of know functions or components are omitted where appropriate.

Identical or similar reference numerals are used consistently for elements in the drawings that are either identical or functionally similar across the specification. Elements within embodiments with the same or similar functions are labeled accordingly. Terms used throughout the specification and claims are not to be limited to general or dictionary definitions but should be interpreted in line with the technical scope of the present disclosure, allowing the inventor the freedom to define terms for optimal clarity.

Additionally, the present disclosure is not limited to the above-described embodiments, and a variety of modifications and changes may be made without departing from the essence of the present disclosure. Therefore, it should be noted that aspects of the present disclosure are not limited to the above-described embodiments, and the appended claims and all the equivalents or variations thereto fall within the scope of the present disclosure.

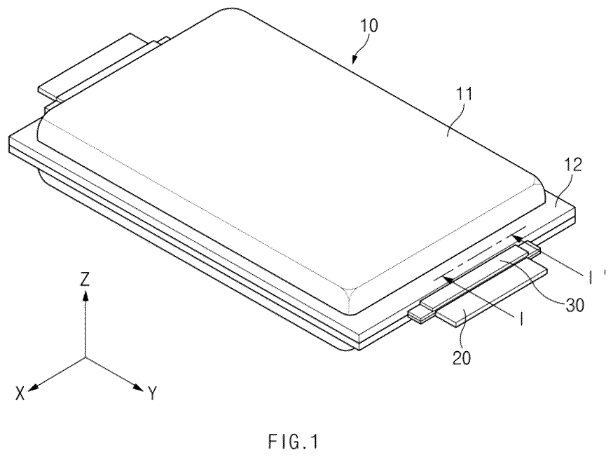

FIG. 1 is a perspective view of a pouch-type secondary battery.

The pouch-type secondary battery may include an outer packaging material or a pouch 10. The pouch 10 may include an accommodation portion 11 accommodating an electrode assembly, and a sealing portion 12 disposed around the accommodation portion 11. The electrode assembly can include an electrode and a separator arranged in an alternating manner, and its structure and operation are well known in the art and its description is omitted.

The pouch 10 may be manufactured by forming a laminate sheet. The laminate sheet may include a first resin layer that forms an inner layer of the pouch 10, a second resin layer that forms an outer layer of the pouch 10, and a metal layer interposed between the first resin layer and the second resin layer. For example, the first resin layer may be made of polypropylene (PP), the second resin layer may be made of polyethylene terephthalate (PET), and the metal layer may be made of aluminum (AL).

The accommodation portion 11 may be formed by shaping the laminate sheet into a recessed cup shape. The sealing portion 12 may be formed by sealing the sides of the pouch 10 along the periphery of the accommodation portion 11 in which the electrode assembly is received.

The pouch-type secondary battery may include a lead metal 20 connected to the electrode assembly and protruding outward beyond sealing portion 12. A lead film 30 covers the lead metal 20 and is sealed with the sealing portion 12.

The lead metal 20 connects to the electrode within the electrode assembly and functions as a conduit for electric current. The lead metal 20 typically includes a pair of leads, with one connected to the positive electrode and the other to the negative electrode. This pair of lead metals 20 may extend outward from the sealing portion 12 in opposite directions, as illustrated in FIG. 1. However, this configuration is not limited to FIG. 1, and in alternative designs, the lead metals may extend parallel to each other in the same direction.

The lead film 30 may partially cover the lead metal 20, providing insulation between the lead metal 20 and the pouch 10. Made from an insulating material, the lead film 30 prevents electrical contact with the pouch 10. During the formation of the sealing portion 12, the lead film 30 is sealed to the inner layer of the pouch 10, ensuring secure insulation and containment.

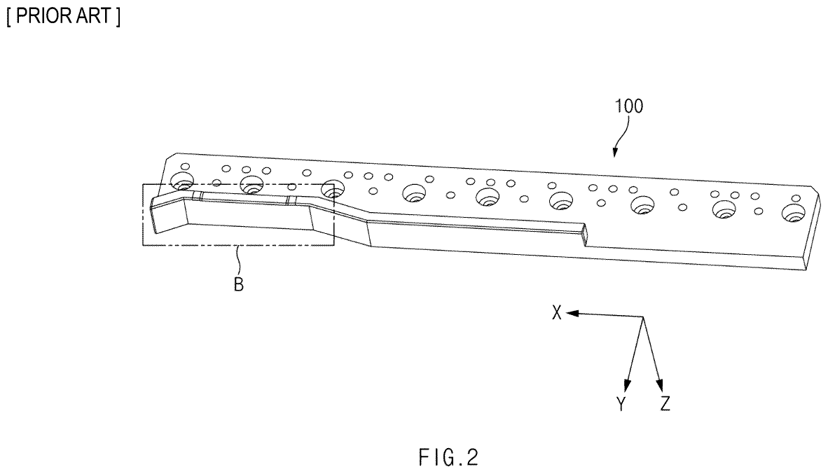

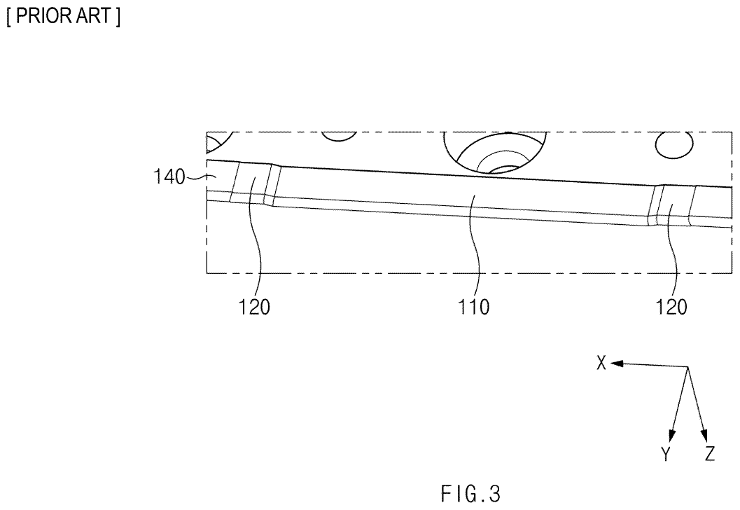

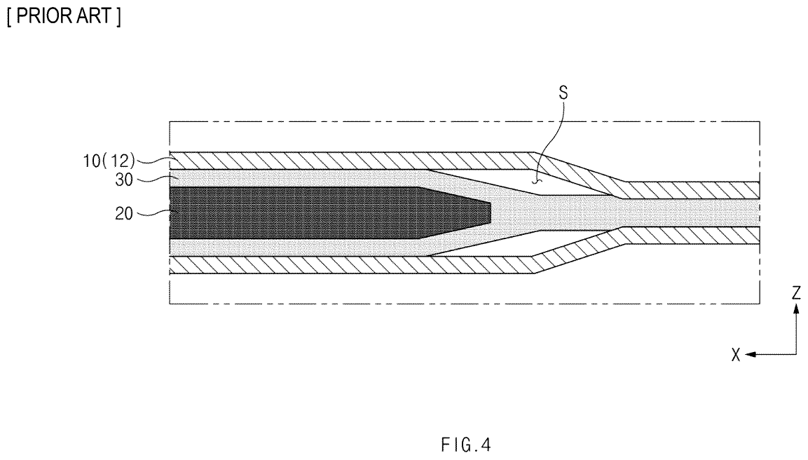

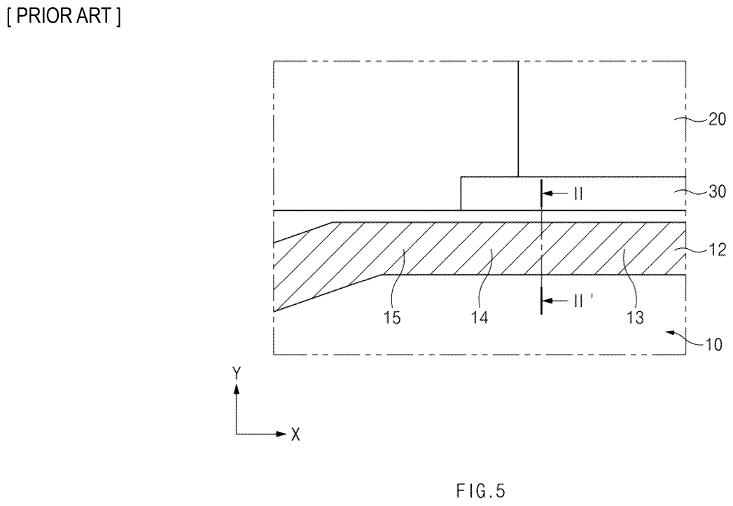

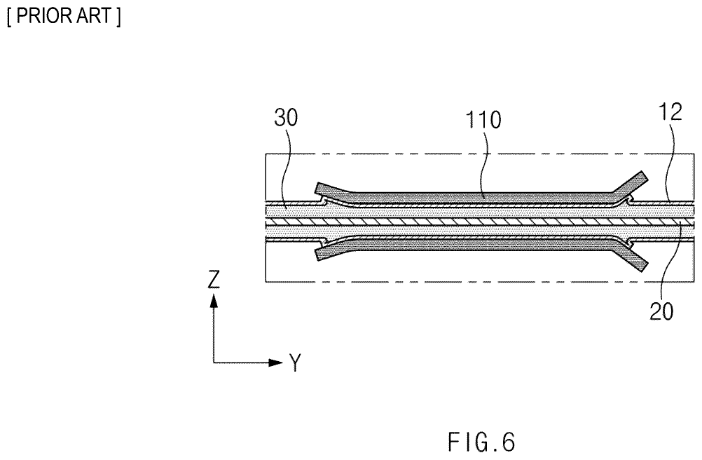

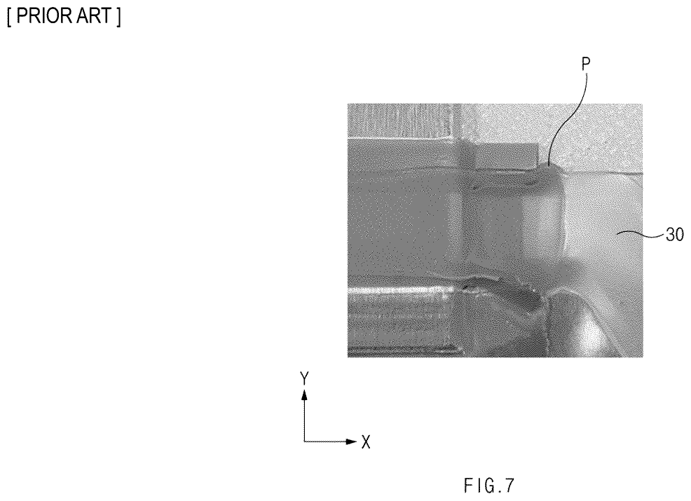

FIGS. 2-7 are directed to a conventions sealing block 100 disclosed herein as a comparative example. FIG. 2 is a perspective view of the conventional sealing block 100 of a sealing apparatus according to the comparative example. FIG. 3 is an enlarged view of section B of FIG. 2. FIG. 4 is a cross-sectional view of FIG. 1, taken along the line I-I′, showing a secondary battery manufactured by the sealing apparatus of the comparative example. FIG. 5 is an enlarged plan view of the sealing portion of the pouch formed by the sealing apparatus of the comparative example and the lead film adjacent thereto. FIG. 6 is a cross-sectional view of FIG. 5, taken along the line II-II′, and FIG. 7 is a diagram showing the lead film protruding in a width direction of a sealing surface during sealing.

The sealing block 100 of the sealing apparatus according to the comparative example is configured to seal the lead film 30 and the pouch 10. The sealing block 100 can thermally join the lead film 30 and the pouch 10 covering the lead film 30 by applying pressure and heat to the lead film 30 and the pouch 10. The sealing block 100 includes a pair of sealing blocks on two sides of the lead film 30 and the pouch 10.

The sealing block 100 includes a plurality of sealing surfaces 110, 120, 140. The sealing surfaces 110, 120, 140 is configured to apply pressure and heat to the pouch 10 covering the lead film 30 while in contact with the pouch 10. The sealing surfaces 110, 120, 140 includes the first sealing surface 110, the second sealing surface 120 and the third sealing surface 140.

The first sealing surface 110 is configured to seal the central portion of the lead film 30 that overlaps the lead metal 20. More specifically, the first sealing surface 110 can seal the central portion of the lead film 30 and the inner layer of the pouch 10.

The second sealing surface 120 is configured to seal the edge portion of the lead film 30. More specifically, the second sealing surface 120 seals the edge portion of the lead film 30 that does not overlap the lead metal 20 and the inner layer of the pouch 10. The second sealing surface 120 is disposed outside of two end portions of the first sealing surface 110 and be stepped from the first sealing surface 110 in a direction (parallel to the z-axis) in which the sealing block 100 applies pressure.

The third sealing surface 140 is disposed outside of the second sealing surface 120. The third sealing surface 140 seals each inner layer of the pouch 10 by applying pressure and heat to the pouch 10.

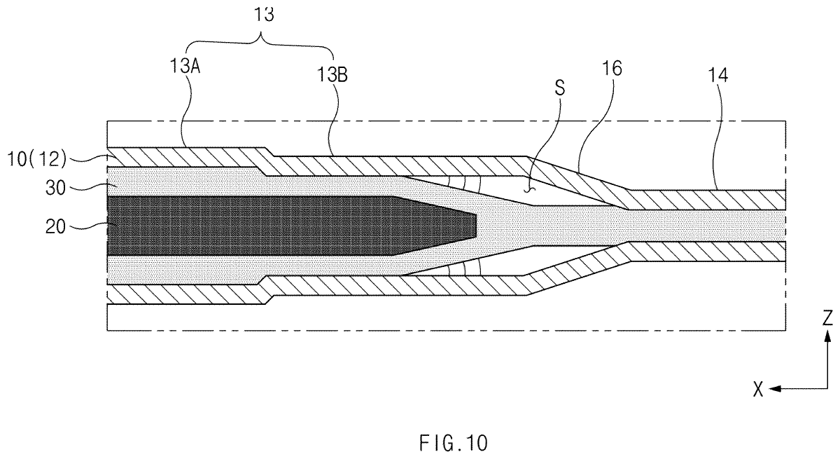

A void S may be created in the pouch 10. Specifically, the void S may be created between the pouch 10 and the lead film 30 as best shown in FIG. 10. This void S occurs at the junction between the first sealing surface 110 and the second sealing surface 120, corresponding to their connected area.

During the sealing process, when the lead film 30 melts and flows along the length direction (parallel to the x-axis) of the sealing surfaces 110 and 120, it can fill the void S, thereby reducing its volume. The length direction (x-axis) of the sealing surfaces 110 and 120 aligns with the width direction of the lead metal 20 and runs parallel to the length of the lead film 30 as shown in FIGS. 3 and 4.

However, in the case of the sealing block 100 of the comparative example, the first sealing surface 110 is designed as a flat plate, which prevents the lead film 30 from flowing adequately in the length direction (parallel to the x-axis). As a result, a larger void S remains, creating a gap between the pouch 10 and the lead film 30 and leading to a decline in the secondary battery's quality.

As shown in FIG. 7, leakage of the lead film 30 can occur when the sealing block 100 applies pressure to seal the pouch 10 and the lead film 30. The lead film 30 is compressed from both sides along its thickness, causing it to protrude (P) in the width direction (parallel to the y-axis) due to the pressure applied from these two directions.

When the lead film 30 protrudes in the width direction (parallel to y-axis), the surface of the pouch 10 covering the lead film 30 may become deformed or wrinkled. Further, a gap may be created between the pouch 10 and the lead film 30.

A sealing apparatus according to an embodiment of the present disclosure disclosed below solve the problems referenced above. A secondary battery sealed by the same will be described with reference to the accompanying drawings.

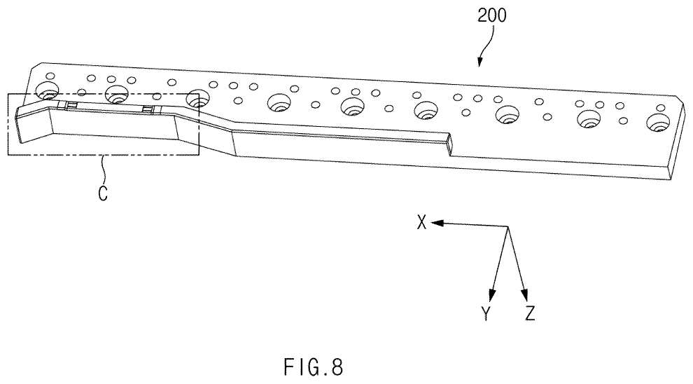

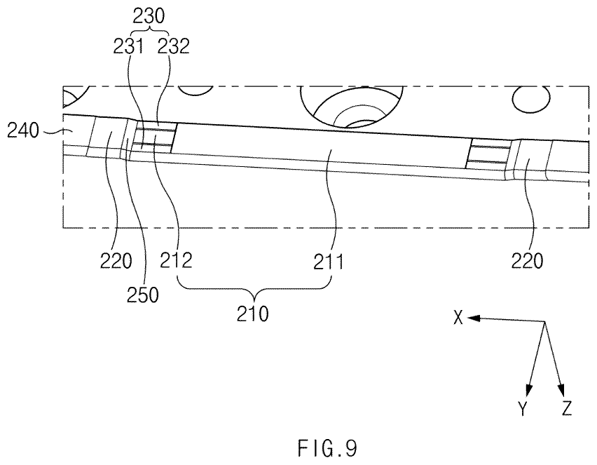

FIG. 8 is a perspective view of a sealing block 200 of a sealing apparatus according to an embodiment of the present disclosure. FIG. 9 is an enlarged view of section C of FIG. 8.

The sealing block 200 in the sealing apparatus is configured to seal both the lead film 30 and the pouch 10. Specifically, the sealing block 200 forms the sealing portion 12 of the pouch-type secondary battery. By applying both pressure and heat, the sealing block 200 thermally bonds the inner layer of the pouch 10 to the lead film 30, creating a secure seal.

The sealing block 200 may include a pair of sealing blocks arranged facing each other in the direction of pressure applied (parallel to z-axis). That is, the pair of sealing blocks 200 may face each other with the secondary battery interposed between them.

The sealing block 200 may be configured to apply pressure and heat to the pouch 10 while in contact with the pouch 10.

The sealing block 200 may include a first sealing surface 210 configured to seal the central portion of the lead film 30 that overlaps the lead metal 20. The first sealing surface 210 may seal the central portion of the lead film 30 and the pouch 10 by applying pressure and heat.

The sealing block 200 may further include a second sealing surface 220 to seal two end portions of the lead film 30 and the pouch 10. The second sealing surface 220 may be stepped with respect to the first sealing surface 210.

The second sealing surface 220 is configured to seal the two end portions of the lead film 30, specifically the sections that do not overlap with the lead metal 20. Positioned outward from the two ends of the first sealing surface 210, the second sealing surface 220 extends further outward in the direction (parallel to the z-axis) along which the sealing block 200 applies pressure. This stepped configuration creates an inclined portion 250 between the first and second sealing surfaces, connecting the two surfaces and facilitating a secure and consistent seal across different sections of the lead film 30.

The sealing block 200 also includes a third sealing surface 240 configured to seal each inner layer of the pouch 10. The third sealing surface 240 is positioned in a stepped configuration relative to the second sealing surface 220, allowing for a multi-layered sealing approach that enhances the overall integrity of the pouch.

The third sealing surface 240 is positioned outside of the second sealing surface 220, providing a side seal for the pouch 10 by applying both pressure and heat. The third sealing surface 240 is stepped so that it extends further than the second sealing surface 220 in the direction of applied pressure (parallel to the z-axis). As a result, the third sealing surface 240, the second sealing surface 220, and the first sealing surface 210 are arranged in a sequential stepped configuration.

The first sealing surface 210 includes a center sealing surface 211 and a side sealing surface 212. The center sealing surface 211 covers the central area of the first sealing surface 210, while the side sealing surface 212 extends to the two end portions. The side sealing surface 212 is stepped with respect to the center sealing surface 211, specifically extending further in the pressure direction (parallel to the z-axis) than the center.

The side sealing surface 212 may be extended from the end portion of the center sealing surface 211, and be stepped with the center sealing surface 211.

The side sealing surface 212 is formed between the center sealing surface 211 and the second sealing surface 220. The side sealing surface 212 may be also stepped with the second sealing surface 220. In other words, the side sealing surface 212 may be stepped with both the center sealing surface 211 and the second sealing surface 220. That is, the center sealing surface 211, the side sealing surface 212 and the second sealing surface 220 may be stepped in a sequential order in the direction of pressure applied (parallel to z-axis).

The stepped configuration allows the lead film 30 to flow more effectively in the length direction (parallel to the x-axis), thereby reducing the void size S and improving the scaling quality.

Additionally, the sealing block 200 includes a sealing protrusion 230, which directs the flow of the molten lead film 30 along the length direction (x-axis) and prevents it from flowing outward in the width direction (y-axis). The sealing protrusion 230 projects from the first sealing surface 210 in the pressure direction (z-axis) and is specifically located on the side sealing surface 212, extending along its length in the shape of a rectangular bar.

The sealing protrusion 230 may protrude from the first sealing surface 210 in the direction (parallel to z-axis) in which the sealing block 200 applies pressure.

Specifically, the sealing protrusion 230 may be disposed in the side sealing surface 212. The sealing protrusion 230 may protrude from the side sealing surface 212. The sealing protrusion 230 may be extended in the length direction of the side sealing surface 212. In other words, the sealing protrusion 230 may be formed in the shape of a rectangular bar.

The sealing protrusion 230 may include a plurality of sealing protrusions. For example, the scaling protrusion 230 may include a pair of scaling protrusions. In this case, the sealing protrusion 230 may include a first sealing protrusion 231, and a second sealing protrusion 232 spaced a predetermined distance apart from the first sealing protrusion 231 in the width direction of the side sealing surface 212. The first sealing protrusion 231 and the second sealing protrusion 232 may be parallel to each other in the width direction of the side sealing surface 212.

The first sealing protrusion 231 and the second sealing protrusion 232 may be located at two edges of the side sealing surface 212 in the width direction, respectively. The first sealing protrusion 231 may be located at the inner edge of the side sealing surface 212, and the second sealing protrusion 232 may be located at the outer edge of the side sealing surface 212.

The first sealing protrusion 231 and the second sealing protrusion 232 may be formed with the same width and length. The first sealing protrusion 231 and the second sealing protrusion 232 may protrude from the side sealing surface 212 to the same height.

The sealing protrusion 230 may be extended in the length direction of the side sealing surface 212. More specifically, the sealing protrusion 230 may be extended between the center sealing surface 211 and the inclined portion 250.

By employing the sealing protrusion 230, it is possible to prevent leakage of the molten lead film 30 in the width direction (parallel to y-axis) of the lead film 30 during sealing of the lead film 30 and the pouch 10 by the sealing block 200. The width direction (parallel to y-axis) of the lead film 30 may be parallel to the length direction of the lead metal 20, i.e., the inward-outward direction of the pouch 10. Additionally, the width direction (parallel to y-axis) of the lead film 30 may be parallel to the width direction of the side sealing surface 212. Therefore, by restricting the molten lead film 30 from leaking in the width direction, the sealing protrusion 230 ensures that the film remains within the desired sealing area, filling the void and preventing defects in the seal along the inward-outward direction of the pouch 10.

FIG. 10 is a cross-sectional view of FIG. 1, taken along the line I-I′, showing a secondary battery manufactured by the sealing block 200 according to an embodiment of the present disclosure.

As shown in FIGS. 9 and 10, the first sealing surface 210 of the sealing apparatus utilizing sealing block 200 is configured to seal the central portion of the lead film 30 where it overlaps with both the lead metal 20 and the pouch 10. Consequently, the sealing portion 12 of the pouch 10 includes a first area 13, where the lead film 30 and the pouch 10 are sealed together, overlapping the lead metal 20. This first area 13 is formed by the pressure applied from the first sealing surface 210, ensuring a secure and consistent seal at this critical overlap.

The second sealing surface 220 of the sealing apparatus seals the two end portions of the lead film 30 that do not overlap the lead metal 20 and the pouch 10. Accordingly, the sealing portion 12 of the pouch 10 may include a second area 14 where the two end portions of the lead film 30 and the pouch 10 are sealed. The second area 14 may be formed by the application of pressure from the second sealing surface 220. Due to the stepped configuration between the first sealing surface 210 and the second sealing surface 220, the first area 13 and the second area 14 of the pouch 10 are also arranged in a stepped manner, enhancing the structural integrity of the seal.

The first sealing surface 210 of the sealing apparatus includes the center sealing surface 211 and the side sealing surface 212. The side sealing surface 212 may be stepped such that it protrudes further from the center sealing surface 211 in the direction (parallel to z-axis) in which the sealing block 200 applies pressure. The center sealing surface 211, the side sealing surface 212 and the second sealing surface 220 may be stepped in a sequential order in the direction (parallel to z-axis) in which the sealing block 200 applies pressure. The side sealing surface 212 may overlap the edge area of the lead metal 20 in the width direction. A void S may form between the lead film 30 and the pouch 10, corresponding to the inclined portion 250, which faces this void S, aiding in the flow and filling of the sealant material during sealing.

As the side sealing surface 212 is stepped to extend further than the center sealing surface 211 in the direction of applied pressure (parallel to the z-axis), it allows for greater pressure to be exerted on the lead film 30 at the overlapping area with the side sealing surface 212. Specifically, this higher pressure is applied in the z-axis direction, resulting in more force on the lead film 30 in this region compared to the overlapping area with the center sealing surface 211. This configuration forces the molten lead film 30 to flow along the length direction (parallel to the x-axis) of the side sealing surface 212, directing it into the void S. As a result, the volume of void S is reduced, improving the seal's effectiveness and structural integrity.

Because the first sealing surface 210 includes the center sealing surface 211 and the side sealing surface 212, the first area 13 of the sealing portion 12 of the pouch 10 may include a center area 13A and a side area 13B. The center area 13A may be formed by the application of pressure from the center sealing surface 211, and the side area 13B may be formed by the application of pressure from the side sealing surface 212.

The center area 13A may overlap the central portion of the lead metal 20, and the side area 13B may overlap two edges of the lead metal 20 in the width direction. The side area 13B may be located at two sides of the center area 13A. The side area 13B may be stepped with respect to the center area 13A. More specifically, the side area 13B may be stepped toward the lead film 30 with respect to the center area 13A. That is, because the side area 13B is subjected to larger pressure than the center area 13A, the molten lead film 30 may be more likely to flow into the void S, and the volume of the void S may be reduced.

Additionally, the second area 14 may be stepped with respect to the side area 13B. More specifically, the second area 14 may be stepped toward the lead film 30 with respect to the side area 13B. That is, in the thickness direction of the sealing portion 12, the center area 13A, the side area 13B and the second area 14 may be stepped in a sequential order.

The sealing portion 12 of the pouch 10 may further include an inclined area 16 between the side area 13B and the second area 14. The inclined area 16 may be formed by the application of pressure from the inclined portion 250 of the sealing block 200. The inclined area 16 may be extended at an angle between an end portion of the side area 13B and an end portion of the second area 14.

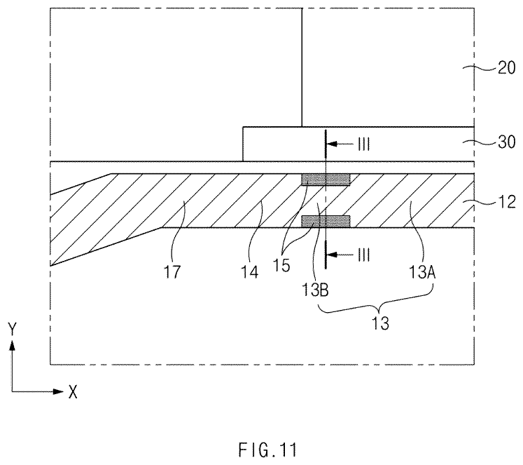

The sealing portion 12 of the pouch 10 may further include a third area 17 (see FIG. 11) where each inner layer of the pouch 10 is sealed. The third area 17 may be formed by the application of pressure from the third sealing surface 240. Because the second sealing surface 220 and the third sealing surface 240 of the sealing apparatus are stepped with each other, the second area 14 and the third area 17 of the pouch 10 may be stepped with each other. More specifically, the third area 17 may be stepped toward the inner layer of the pouch 10 with respect to the second area 14.

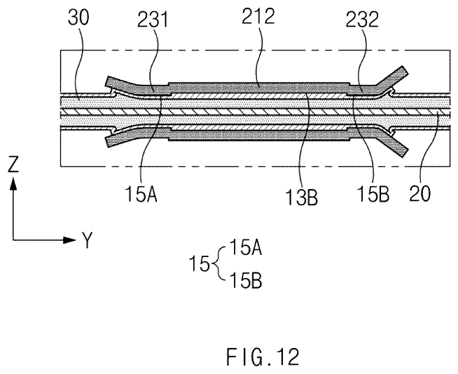

FIG. 11 is an enlarged plan view of the sealing portion of the pouch formed by the sealing apparatus utilizing sealing block 200 and the lead film adjacent thereto. FIG. 12 is a cross-sectional view of FIG. 11, taken along the line III-III′.

Referring to FIGS. 9, 11 and 12, the sealing protrusion 230 may be disposed in the side sealing surface 212. The pair of sealing protrusions 230 may be arranged at a predetermined interval in the width direction of the side sealing surface 212. The first sealing protrusion 231 may be formed at the inner edge of the side sealing surface 212, and the second sealing protrusion 232 may be formed at the outer edge of the side sealing surface 212.

When the sealing block 200 applies pressure to the pouch 10, a larger pressure may be applied to the lead film 30 at a corresponding location to the sealing protrusion 230 than the area at which the sealing protrusion 230 is not formed.

In other words, the pressure by the sealing protrusion 230 may be applied to a portion of the lead film 30 corresponding to the two edges of the side sealing surface 212 in the width direction, thereby preventing the molten lead film 30 from flowing in the width direction (parallel to y-axis) of the side sealing surface 212, i.e., the inward-outward direction of the pouch 10.

In this case, the lead film 30 subjected to pressure by the side sealing surface 212 may move to fill the void S between the pouch 10 and the lead film 30, rather than moving in the inward-outward direction of the pouch 10. That is, the flow of the lead film 30 in width direction (parallel to y-axis) of the side sealing surface 212 may be restricted by the sealing protrusion 230, and the lead film 30 may be allowed to flow in the length direction (parallel to x-axis) of the side sealing surface 212 and fill the void S (see FIG. 10).

By the sealing protrusion 230 of the sealing apparatus, a pressed portion 15 may be formed in the sealing portion 12 of the pouch 10. The pressed portion 15 may be formed by the application of pressure from the sealing protrusion 230. The pressed portion 15 may be formed in the side area 13B, and be extended in the length direction (parallel to x-axis) of the side area 13B. The pressed portion 15 may be formed at two edges of the side area 13B of the sealing portion 12 in the width direction (parallel to y-axis).

The pressed portion 15 may include a pair of pressed portions arranged at a predetermined interval in the width direction (parallel to y-axis) of the side area 13B. More specifically, the pressed portion 15 may include a first pressed portion 15A formed along the inner edge of the side area 13B, and a second pressed portion 15B formed along the outer edge of the side area 13B.

The length of the pressed portion 15 may correspond to the length of the side area 13B. That is, the length of the pressed portion 15 may be equal or similar to the length of the side area 13B.

Meanwhile, because the sealing block 200 applies pressure to two sides of the pouch 10 to form the sealing portion 12, two surfaces of the sealing portion 12 may have a symmetrical shape. That is, the first area 13 may be located on the two surfaces of the sealing portion 12. More specifically, the center area 13A, the side area 13B and the pressed portion 15 may be located on the two surfaces of the sealing portion 12. Likewise, the second area 14, the inclined area 16 and the third area 17 may be also located on the two surfaces of the sealing portion 12.

Thus, in this configuration, the lead film 30 is directed to flow into the void S between the pouch 10 and the lead film, rather than moving outward from the pouch. This control is achieved by the sealing protrusion 230, which restricts lateral flow (parallel to the y-axis) and guides the lead film 30 along the length (x-axis) of the side sealing surface 212, effectively filling the void S (FIG. 10).

The sealing protrusion 230 also creates a pressed portion 15 within the side area 13B of the sealing portion 12. This pressed portion 15 runs along the length (x-axis) of the side area 13B and appears at two edges along the width (y-axis). It consists of a pair of pressed sections: a first pressed portion 15A along the inner edge and a second pressed portion 15B along the outer edge of the side area 13B, both extending the full length of the side area.

Due to the symmetrical pressure applied by the sealing block 200 on both sides of the pouch 10, the sealing portion 12 forms with a symmetrical structure. Consequently, the first area 13, including the center area 13A, side area 13B, and pressed portion 15, is mirrored on both surfaces of the sealing portion 12. Similarly, the second area 14, inclined area 16, and third area 17 appear symmetrically on both surfaces.

This symmetrical sealing configuration not only reinforces the seal's structural integrity but also enhances the battery's durability by minimizing potential weak points. The controlled flow facilitated by the sealing protrusion 230 ensures a compact seal without voids, contributing to a longer-lasting and more reliable battery.

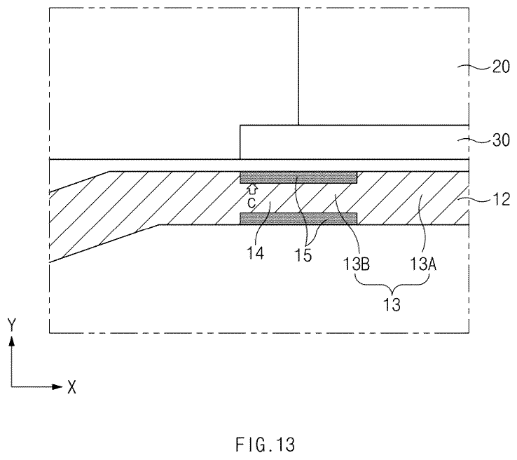

FIG. 13 is an enlarged plan view of a sealing portion of a pouch formed by a sealing apparatus according to another embodiment of the present disclosure and the lead film adjacent thereto.

In this embodiment, the sealing protrusion 230 of the sealing apparatus is extended to the second sealing surface 220 over the side sealing surface 212. With the exception of this difference, it is noted that the previous description of the secondary battery according to the embodiment utilizing sealing block 200 is similar. Accordingly, the common description to sealing block 200 is omitted in this description.

Referring to FIG. 13, the sealing protrusion 230 may be extended to the second sealing surface 220. That is, the sealing protrusion 230 may be formed across the side sealing surface 212 and the second sealing surface 220. More specifically, the sealing protrusion 230 may be extended between the center sealing surface 211 and the third sealing surface 240.

In this case, it may be possible to prevent additional leakage (c) of the lead film 30 that may occur at the area of the lead film 30 that does not overlap the lead metal 20.

Additionally, in the case of the secondary battery manufactured by the sealing apparatus, the pressed portion 15 formed in the sealing portion 12 may be extended to the second area 14 over the side area 13B. The pressed portion 15 may be extended between the center area 13A and the third area 17.

Thus, as shown in FIG. 13, the sealing protrusion 230 spans from the center sealing surface 211, across the side sealing surface 212, and reaches the second sealing surface 220. This configuration, which extends the sealing protrusion between the center sealing surface 211 and the third sealing surface 240, is specifically designed to further prevent leakage of the lead film 30, particularly in regions not overlapping with the lead metal 20.

Moreover, in this embodiment, the pressed portion 15 within the sealing portion 12 of the pouch also extends over the second area 14 from the side area 13B, running between the center area 13A and the third area 17.

This extended sealing configuration enhances the seal by providing an additional layer of containment, reducing the risk of leakage at the edges. By extending the pressed portion and sealing protrusion across more surfaces, the design minimizes potential weaknesses, ensuring greater durability and resistance against external stressors, which is essential for maintaining battery performance over extended use.

Although the present disclosure has been hereinabove described with respect to a limited number of embodiments and drawings, the foregoing description is provided to describe the technical aspect of the present disclosure by way of example, and a variety of modifications and changes may be made by persons having ordinary skill in the technical field pertaining to the present disclosure without departing from the essential features of the present disclosure.

Accordingly, the disclosed embodiments are provided to describe the technical aspect of the present disclosure but not intended to be limiting, and the technical scope of the present disclosure is not limited by these embodiments. The scope of protection of the present disclosure should be interpreted by the appended claims, and it should be interpreted that all the technical aspect in the equivalent scope is included in the scope of protection of the present disclosure.

What is claimed is:

1. A sealing apparatus comprising:
a sealing block configured to seal a lead film covering a lead metal and a pouch covering the lead film,
wherein the sealing block includes a first sealing surface configured to seal a central portion of the lead film overlapping the lead metal,
wherein the first sealing surface comprises:
a center sealing surface extending in a first direction from a first end to a second end; and
a side sealing surface positioned on each end of the center sealing surface and stepped relative to the center sealing surface, and
wherein the side sealing surface includes a sealing protrusion extending to a predetermined thickness away from the center sealing surface, the sealing protrusion configured to prevent the lead film from flowing in a second direction normal to the first direction.

2. The sealing apparatus according to claim 1, wherein the side sealing surface is stepped from the center sealing surface such that the side sealing surface is inclined toward a third direction normal to the first and second directions.

3. The sealing apparatus according to claim 1, wherein the sealing block further includes:
a second sealing surface stepped relative to the first sealing surface, the second sealing surface configured to seal two end portions of the lead film and the pouch.

4. The sealing apparatus according to claim 3, wherein the center sealing surface, the side sealing surface and the second sealing surface are stepped relative to each other in a sequential order in a third direction normal to the first and second directions.

5. The sealing apparatus according to claim 1, wherein the side sealing surface is configured to overlap an end area of the lead metal in the width direction.

6. The sealing apparatus according to claim 3, wherein an inclined portion extends at an angle between an end portion of the side sealing surface and an end portion of the second sealing.

7. The sealing apparatus according to claim 3, wherein the sealing protrusion extends along the third direction.

8. The sealing apparatus according to claim 3, wherein the sealing protrusion includes a plurality of sealing protrusions arranged at predetermined distances from each other along the second direction.

9. The sealing apparatus according to claim 3, wherein the sealing protrusion is formed at edges of the side sealing surface along the second direction.

10. The sealing apparatus according to claim 8, wherein the sealing protrusions include a first sealing protrusion and a second sealing protrusion, the first sealing protrusion formed at an edge of the side sealing surface in the second direction, the second sealing protrusion formed at an opposite edge of the side sealing surface in the second direction.

11. The sealing apparatus according to claim 7, wherein the sealing protrusion extends to the second sealing surface beyond the side sealing surface.

12. The sealing apparatus according to claim 1, wherein the sealing block includes a pair of sealing blocks arranged facing each other in a direction along which pressure is applied.

13. A secondary battery comprising:
a pouch including an accommodation portion accommodating an electrode assembly, and a sealing portion disposed around the accommodation portion to seal the electrode assembly therein;
a lead metal connected to the electrode assembly and extending outward across the sealing portion; and
a lead film covering the lead metal and sealed with the sealing portion,
wherein the sealing portion includes a first area where the pouch and the lead film are sealed, the first area overlapping the lead metal,
wherein the first area includes:
a center area; and
a side area located on two ends of the center area and stepped relative to the center area, and
wherein the side area has a pressed portion defined by a compressed region extending in a length direction of the side area.

14. The secondary battery according to claim 13, wherein the pressed portion includes a pair of pressed portions extending parallel to each other and arranged at a predetermined interval in a width direction of the side area.

15. The secondary battery according to claim 13, wherein the pressed portion is formed at two edges of the side area in a width direction.

16. The secondary battery according to claim 13, wherein the sealing portion further includes a second area where two end portions of the lead film and the pouch are sealed, the second area being stepped relative to the first area.

17. The secondary battery according to claim 16, wherein in a thickness direction of the sealing portion, the center area, the side area and the second area are sequentially stepped relative to each other.

18. The secondary battery according to claim 16, wherein the sealing portion further includes an inclined area formed between the side area and the second area, the inclined area extending at an angle between an end portion of the side sealing surface and an end portion of the second sealing surface.

19. The secondary battery according to claim 16, wherein the pressed portion extends to the second area beyond the side area.

20. An electrical vehicle comprising the secondary battery of claim 13 as a power source.
